(19) United States
(12) Patent Application Publication
(10) Pub. No.: US 2013/0049994 A1
(43) Pub. Date: Feb. 28, 2013

(54) HIGHWAY SPEED MONITORING AND PENALTY DISPLAY SYSTEM

(71) Applicant: Ken Nicholson, Coombs (CA)

(72) Inventor: Ken Nicholson, Coombs (CA)

(21) Appl. No.: 13/592,076

(22) Filed: Aug. 22, 2012

Related U.S. Application Data
(60) Provisional application No. 61/526,634, filed on Aug. 23, 2011.

(51) Int. Cl. G08G 1/01

(52) U.S. Cl. 340/936

(57) ABSTRACT

A road mounted traffic radar system detects the speed of oncoming vehicles using a speed measuring system. The speed is displayed to the driver using a suitable illuminated first display panel. If the speed is over the posted limit, the penalty for the amount of speed over the posted limit is displayed on a second illuminated display panel. The penalty can be expressed In monetary terms or as a combination of monetary and demerit points.

### CROSS-REFERENCE TO RELATED APPLICATIONS

This application claims the benefit of U.S. Provisional Patent Application No. 61/526,634 filed on Aug. 23, 2011 for the same invention by the same inventor.

### FEDERAL SPONSORSHIP

N/A

### BACKGROUND OF THE INVENTION

1. Field of the Invention

This invention relates to signs, picture and sign exhibiting, (Class 40) and more particularly to a sign having a changing exhibitor, and specifically to a highway speed monitoring and penalty display system.

2. Prior Art

Radar speed signs and road traffic monitoring apparatus are well known. These apparatus are ideal for controlling traffic speeds on Industrial sites, schools, colleges, car parks, private roads, caravan parks, wherever road safety is paramount This equipment is used to enhance road safety, reducing traffic speed and conducting traffic census. The radar speed sign does have proven ability to positively influence driver behaviour, reduce speeding by drawing attention to local limits. The radar speed sign can be fixed or mobile, it can be powered by mains, battery or solar to suit particular needs. Typically the radar speed sign uses Doppler radar and is ideal for use in car parks, private roads, caravan parks, quarries, industrial sites, sewage works, farm yards, increasing road safety wherever it's installed. It can also be used to collect traffic census data and speed logging.

Although the radar speed sign does have benefits, drivers will often ignore the posted speed on the sign if the sign is located in a remote area or if there Is no visible law enforcement officer nearby. Furthermore, drivers will often use the radar speed sign as a game or use it to calibrate their own speedometer at speeds much higher than the posted speed limit.

Hefty financial penalties combined with the accumulation of demerit points leading to a loss of a driver's license provide a strong incentive to drivers to slow clown and obey the speed limit. A speeding ticker can prove to be a major inconvenience if the driver is summoned to court, A radar speed sign by itself does not make the connection in the mind of the driver between speed and penalty.

Therefore, there is a continued need to provide a traffic calming device that combines a radar speed device with a display of the penalties associated with speeding so that a driver is incentivised to slow down and obey the speed limit.

### SUMMARY OF THE INVENTION

In order to overcome the shortcomings identified above, my invention is a traffic radar unit and display system for determining a speed of a target vehicle and displaying speed with penalties for speeding. The system may be fixed in place or portable. The system comprises a speed measuring device such as a Doppler radar for emitting a radar signal towards the target vehicle and generating a reflected return radar signal. The radar receiver receives the return signal. A first microprocessor converts the return signal into a speed of the target vehicle. The speed is then displayed on a first display. A second microprocessor converts the speed to a penalty by associating the speed with a penalty established by enforcement officials. The penalty data is stored in a second storage device. The penalty is then displayed to driver.

In one embodiment of the invention there is a first bulk data storage device connected to the first microprocessor for logging a set of data comprising a vehicle field, a recorded speed field for the vehicle, a time of day field and an amount over the posted speed limit field for the vehicle.

In another embodiment of the invention the first microprocessor calculates the amount over the posted speed limit field for the vehicle and stores the amount in the amount over the posted speed limit field for retrieval.

In yet another embodiment of the invention the system further comprises a power source being one of one or a combination of AC power, DC battery power and solar power.

In a further embodiment of the invention, the system includes a transmitter for transmitting the set of data to a control centre.

The invention further includes a set of penalties stored on a second bulk data storage device. The set of penalties may include a fine and a number of demerit points.

In still another embodiment of the invention, the second display is disposed below the first display. The second display may also be disposed above the first display. Alternatively, the second display is integrated into the first display. The second display may display the fine only or it may display the fine and then number of demerit points in an alternating manner.

### BRIEF DESCRIPTION OF THE FIGURES

FIG. 1 is a photograph depicting one embodiment of the invention.

FIG. 2 is a schematic depicting the components of one embodiment of the invention.

FIG. 3 is a diagram depicting another embodiment of the invention.

FIG. 4 is a diagram of one embodiment of a display sign.

FIG. 5 is a diagram of another embodiment of a display sign.

### DESCRIPTION OF THE INVENTION

Referring to the figures, the invention 10 is a highway speed monitoring and penalty display system using a traffic radar system for determining a speed of a target vehicle. In one embodiment of the invention, the system comprises a Doppler radar signal generator 12 for emitting a radar signal 14 towards the target vehicle and generating a reflected radar return signal 18. The reflected return signal is detected by a radar receiver disposed adjacent to the radar signal generator 12. A first microprocessor 20 converts the reflected radar signal 18 into a speed figure for the target vehicle 16. The speed figure is displayed on a first display 24 to the driver of the target vehicle. A second microprocessor 26 converts the speed of the target vehicle to a penalty. A second display 28 displays the penalty to the driver. The radar emitter and receiver may be integrated into the first or the second display. Speed measurement may also be accomplished by a LIDAR device and by a video camera device with suitable microprocessors and software to convert input received by these devices to a speed signal.

A first bulk data storage device 30 is connected to the first microprocessor 20 for recording a set of data 32 comprising at least a vehicle field 34, a recorded speed field 36 for the vehicle, a time of day field 38 and an amount over the posted speed limit field 40 for the vehicle. Alternatively, a camera may be attached to the first or second display tor photographing the vehicle and/or the vehicle license plate. The photograph is then digitized and stored within an additional data field.

The first microprocessor calculates the amount over the posted speed limit field for the vehicle and stores the amount in the amount over the posted speed limit field 40 for retrieval

The system further comprises a power source 41. The power source is one or a combination of AC power, DC battery power and solar power 43.

Optionally the system may include a transmitter 42 for transmitting the set of data to a control centre 45. Transmitted data can comprise vehicle field 34, recorded speed field 36 for the vehicle, time of day field 38 and the amount over the posted speed limit field 40 for the vehicle. The vehicle photo and identification tag information may also be transmitted. In cases where excessive speeding is apparent, this data can be used for further identification of the owner of the vehicle and prosecution of the owner under appropriate highway and traffic control laws.

The penalty comprises a set of penalties stored on a second bulk data storage device 44. The penalties include a data base of fines 46 and a database of number of demerit points 48 associated with the speeding infraction. The database can be uploaded from any jurisdictional authority and can be updated 47 using remote means through transmitter 42.

In this diagram, the second display 28 is disposed below the first display 24.

In one embodiment of the invention the second display is integrated into the first display and speed, fine and demerit points are displayed in sequence.

The system may use the second display to display the fine only. Alternatively system second display displays the fine and then the number of demerit points.

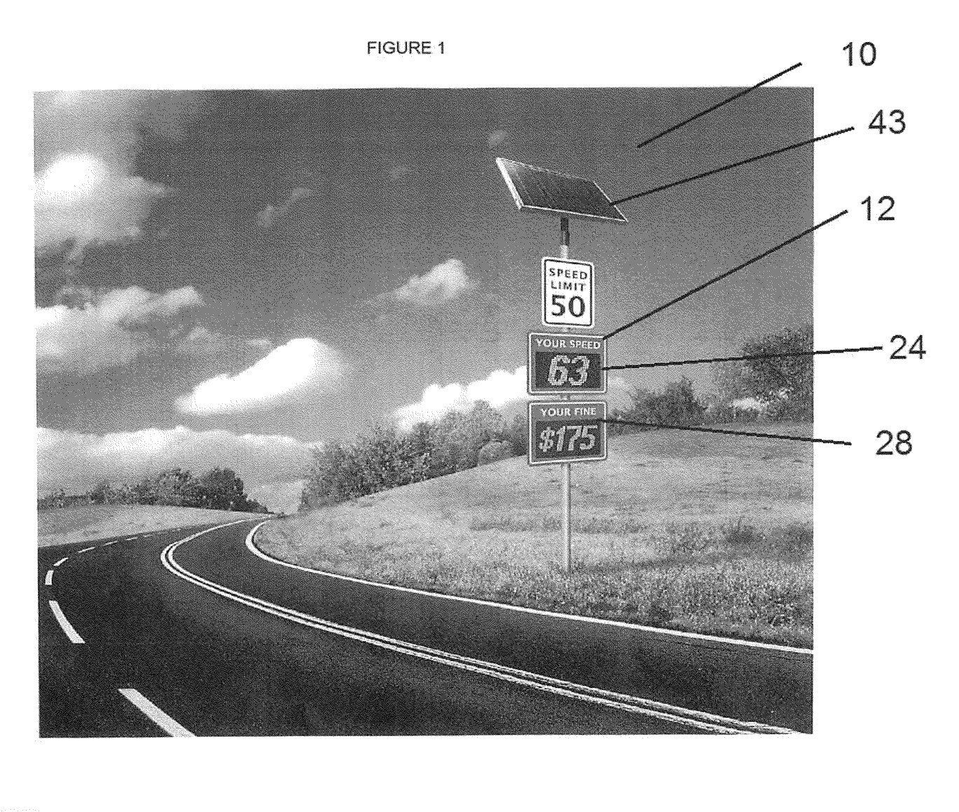

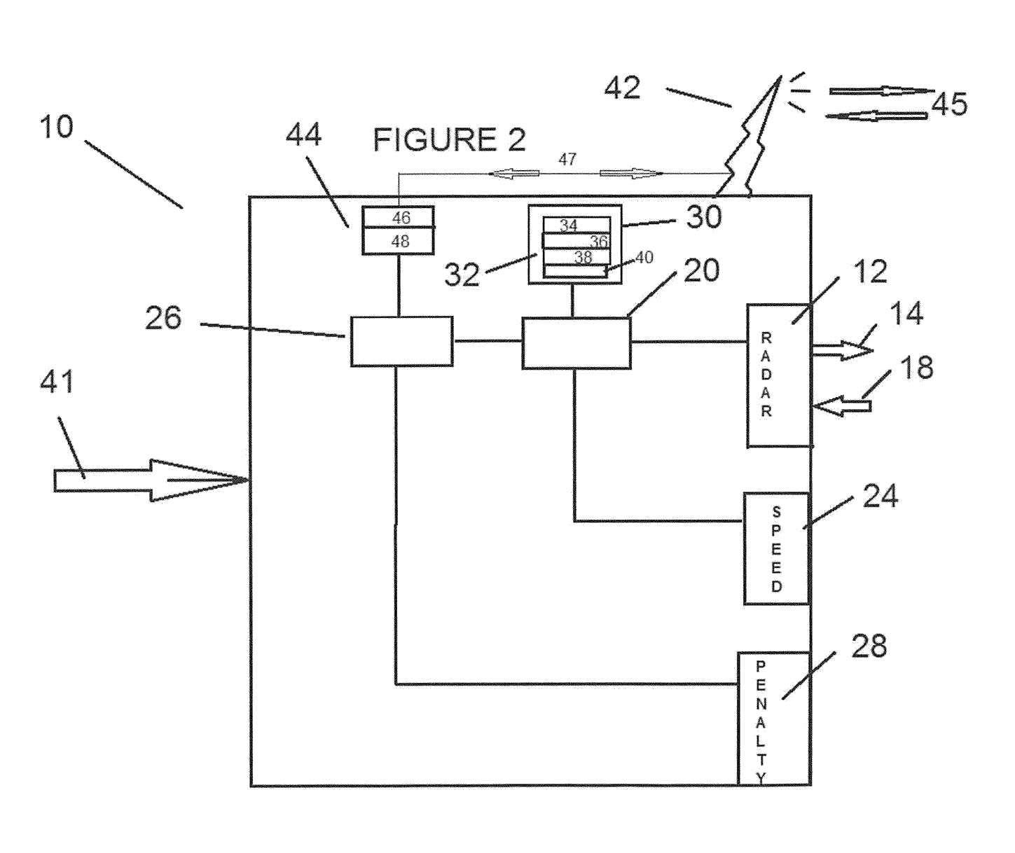

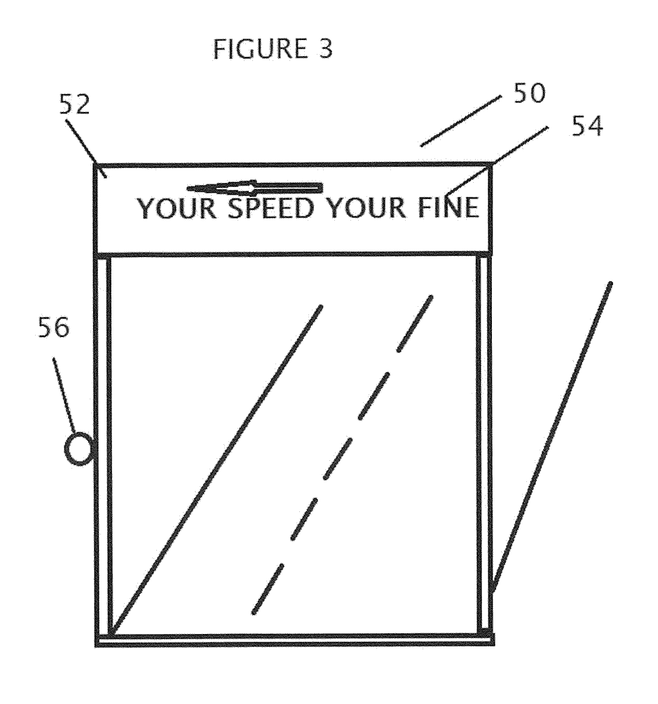

Referring to FIG. 3, the invention may be adaptable to existing overhead signs 50 that display dynamic messages 52. The message “YOUR SPEED ______ YOUR FINE ______” 54 would be displayed across the sign board 50 prior to the vehicle passing underneath the sign. In one embodiment the sign can be programmed by the invention to rely a static set of data based on speed and related penalty. In another embodiment of the invention the sign includes the radar speed detector 56 and the overhead sign is used as a display sign for the invention for a horizontal display instead of a vertical display as shown in FIG. 1. A camera can also be included in this embodiment to identify the vehicle.

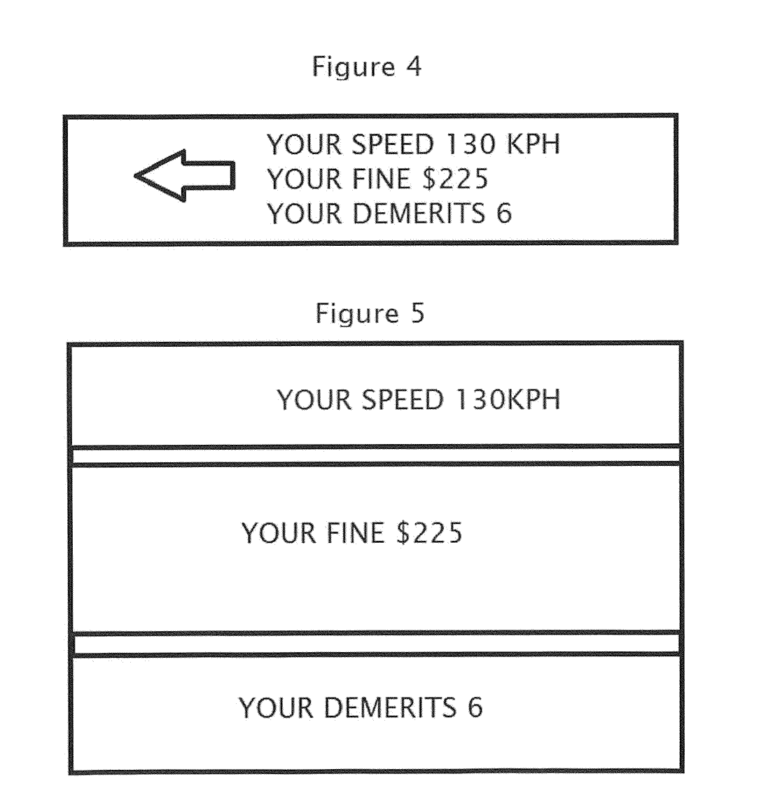

Referring to FIG. 4, there is shown one embodiment of a cross-highway sign of FIG. 3 illustrating the format for displaying speed, fine and demerit points. The information would scroll across the sign at a speed suitable for a driver to see the full amount of data displayed before passing underneath the sign.

Referring to FIG. 5, there is shown another embodiment of a sign fixed to a sign post as in FIG. 1, wherein there is one display panel of LEDs programmed by the microcontroller of the invention to display the speed, fine and demerits in a vertical fashion. Lines of LEDs would remain off so that there would appear to be lines between the data fields. The figures shown on the sign could also be blinking.

From the foregoing description the novelty, utility, and means of producing and practicing my invention will be readily apprehended. However, the foregoing description merely represents the best mode known to me as of the present date. The embodiments herein disclosed are not meant to be exclusive of other ways of practicing my invention, and it will be obvious to those of average skill in the field that other means of practicing the invention lie within the scope of this disclosure and the claims, below. Consequently, the metes and bounds of my invention are not limited to the embodiments disclosed above but encompass any and all embodiments within the scope of the following claims.

The embodiments of the invention in which an exclusive property or privilege is claimed are defined as follows:

1. A highway speed monitoring and penalty display system comprising:
a. a speed measuring device for generating a speed signal of a target vehicle;
b. a first microprocessor for converting said speed signal into a measured speed of said target vehicle;
c. a first display for displaying said measured speed of the target vehicle to a driver of the target vehicle;
d. a second microprocessor for converting the measured speed of the target vehicle to a penalty;
e. a second display for displaying said penalty to said driver and,
f. an integral power source for powering the system.

2. The system of claim 1 wherein said speed measuring device is one of a Doppler radar device, a LIDAR device and a video camera.

3. The system of claim 2 further comprising a first bulk data storage device connected to said first microprocessor for recording a set of data comprising at least; a vehicle field, a recorded speed field for said vehicle, a time of day field and an amount over the posted speed limit field for the vehicle.

4. The system of claim 3 wherein the first microprocessor calculates said amount over the posted speed limit field for the vehicle and stores the amount in said amount over the posted speed limit field for retrieval,

5. The system of claim 4 further wherein said video camera device obtains a digital photograph of the identity license plate of the vehicle.

6. The system of claim 5 wherein said first bulk data storage device further includes a data field for storage of said digital photograph.

7. The system of claim 6 wherein said power source Is one or a combination of AC power, DC battery power and solar power.

8. The system of claim 7 further comprising a transmitter for transmitting said set of data to a control centre.

9. The system of claim 8 wherein the penalty comprises a set of penalties stored on a second bulk data storage device.

10. The system of claim 9 wherein said set of penalties Includes a fine and a number or demerit points.

11. The system of claim 10 wherein said second display is disposed below the first display.

12. The system of claim 11 wherein the second display is integrated into the first display.

13. The system of claim 12 wherein the second display displays said fine only.

14. The system of claim 13 wherein the second display displays the fine and then said number of demerit points sequentially.

15. The system of claim 14 wherein said transmitter transmits by one of a radio frequency, a cellular telephone and a land line.
